(19) United States
(12) Patent Application Publication
(10) Pub. No.: US 2020/0337492 A1
(43) Pub. Date: Oct. 29, 2020

(54) ELECTRONIC WATER SUPPLY KIT FOR COFFEE MAKER

(71) Applicant: Ryan Pederson, Eden Prairie, MN (US)

(72) Inventor: Ryan Pederson, Eden Prairie, MN (US)

(21) Appl. No.: 16/856,894

(22) Filed: Apr. 23, 2020

Related U.S. Application Data
(60) Provisional application No. 62/837,706, filed on Apr. 23, 2019.

(51) Int. Cl. A47J 31/46

(52) U.S. Cl. CPC A47J 31/469; A47J 31/461

(57) ABSTRACT

An electronic water supply kit is disclosed that can be used to fill a reservoir of a coffee maker. The kit includes a valve, a momentary switch and a power cord assembly. The power cord assembly includes a first cable that connects the valve to a power supply, a second cable that connects the power supply to the momentary switch and a third cable that connects the momentary switch to the valve. During operation, the momentary switch is operated to allow water to flow through the valve from a water supply to the reservoir.

### BACKGROUND

Coffee makers come in various forms and include various features to assist in brewing coffee. Current coffee makers include a water reservoir that provides water for making coffee. In some current coffee makers, water is automatically supplied to the reservoir from a source external to the coffee maker. In some instances, automatic mechanisms that supply water to the reservoir can fail, causing undesirable overflowing and/or flooding of the reservoir.

### SUMMARY

An electronic water supply kit is disclosed that can be used to fill a reservoir of a coffee maker. The kit includes a valve, a momentary switch and a power cord assembly. The power cord assembly includes a first cable that connects the valve to a power supply, a second cable that connects the power supply to the momentary switch and a third cable that connects the momentary switch to the valve. During operation, the momentary switch is operated to allow water to flow through the valve from a water supply to the reservoir.

### BRIEF DESCRIPTION OF THE DRAWINGS

FIG. 1 is a schematic view of a water supply assembly kit for a coffee maker.

### DESCRIPTION

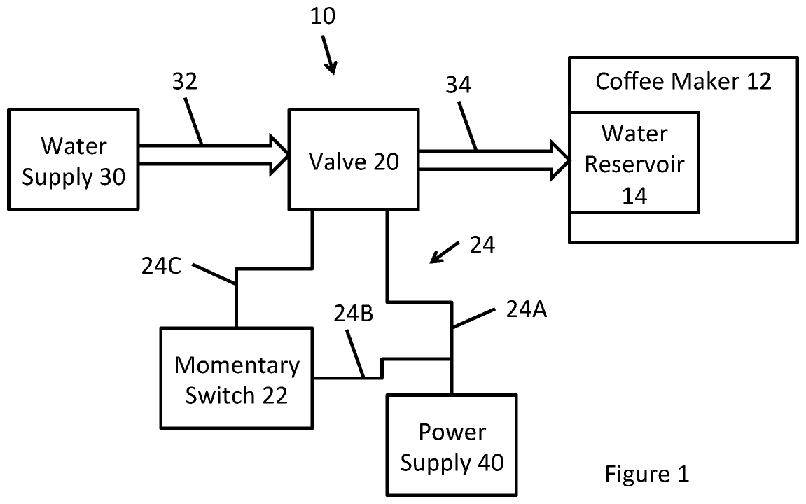

FIG. 1 is a schematic view of an elctronic water supply kit 10 for use with a coffee maker 12 having a water reservoir 14. The kit 10 includes a valve 20, a momentary switch 22 and a cord assembly 24, which includes cables 24A, 24B and 24C.

Valve 20 is fluidly coupled between a water supply 30 and reservoir 14. The water supply 30 can be a conventional water supply (e.g., a cold water line, a drinking water line) in a home or office setting. In the embodiment illustrated, a first tube or conduit 32 connects the water supply 30 with the valve 20 and a second tube or conduit 34 connecting the valve 20 to the water reservoir 14. The valve 20 operates in an open position to allow flow of water from tube 32 to tube 34 or in a closed position to stop flow of water from tube 32 to tube 34. In one embodiment, the valve 20 is spring-loaded in and normally in the closed position. As a result, if power is removed from the valve 20, the valve 20 will be in the closed position and accordingly prevent water flowing from tube 32 to tube 34. In one embodiment, tube 34 can be connected with water reservoir 14 through a hole in the water reservoir 14. Furthermore, a grommet or other device can be used to provide a connection and seal between an end of tube 34 and the water reservoir 14.

Momentary switch 22 can include a manually operated interface (e.g., a push-button) or other device (e.g., a remote control) that, when operated, supplies an electrical signal to valve 20. In response to the electrical signal, valve 20 transitions from the closed position to the open position.

Cord assembly 24 connects a power supply 40 with valve 20 and momentary switch 22. In particular, cable 24A of cord assembly 24 electrically connects the power supply 40 with the valve 20. Additionally, cable 24B of cord assembly 24 electrically connects the power supply 40 with the momentary switch 22. In one embodiment, the power supply 40 can include a conventional wall outlet and an adapter that transforms power to a 12V signal that is supplied to the valve 20 and momentary switch 22. Cord assembly 24 also includes cable 24C, which electrically connects momentary switch 22 with valve 20. In one embodiment, cables 24A, 24B and 24C are insulated wires having connectors at either end for electrically interfacing with components of the kit 10.

Once kit 10 is installed, valve 20 is in the closed position and water is prevented from flowing from water supply 30 to water reservoir 14. In order to deliver water from water supply 30 to water reservoir 14, a user can operate momentary switch 22, for example by depressing a button. Operation of the momentary switch 22 causes valve 20 to open, allowing water to flow from water supply 30 to water reservoir 14. When water reservoir 14 is full or reaches a desired water level, the user can release the button on the momentary switch 22, causing valve 20 to return to the closed position.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. An electrical water supply kit supplying water from a water supply to a water reservoir of a coffee maker, comprising:
a valve having an open position and a closed position;
a first tube configured to be connected between the valve and the water supply;
a second tube configured to be connected between the valve and the water reservoir;
a momentary switch; and
a cord assembly, comprising:
a first cable configured to electrically connect a power supply to the valve;
a second cable configured to electrically connect the power supply to the momentary switch; and
a third cable configured to electrically connect the momentary switch to the valve;
wherein, upon operation of the momentary switch, the valve moves from the closed position to the open position.

2. The electrical supply kit of claim 1, wherein the valve is spring loaded.

3. The electrical supply kit of claim 1, further comprising a grommet coupling the second tube with the water reservoir.

4. The electrical supply kit of claim 1, wherein the momentary switch includes a push button.

5. The electrical supply kit of claim 1, wherein the first, second and third cables are insulated wires.

6. The electrical supply kit of claim 1, wherein the cord assembly further includes a transformer configured to transform power from a first voltage to a second voltage.

7. The electrical supply kit of claim 1, wherein after operation of the momentary switch, the valve moves from the open position to the closed position.
